(19) United States
(12) Patent Application Publication
(10) Pub. No.: US 2005/0284864 A1
(43) Pub. Date: Dec. 29, 2005

(54) Gas heating device

(75) Inventor: Osamu Yamada, Takatsuki-shi (JP)

Correspondence Address: KNOBBE MARTENS OLSON & BEAR LLP, 2040 MAIN STREET, FOURTEENTH FLOOR, IRVINE, CA, 92614, US

(73) Assignees: Osuma Yamada, Takatsuki-shi (JP); OSU Corporation, Daito-shi (JP)

(21) Appl. No.: 11/086,949

(22) Filed: Mar. 21, 2005

(30) Foreign Application Priority Data
Mar. 22, 2004 (JP) 2004-81830

(51) Int. Cl. H05B 6/26

(52) U.S. Cl. 219/651

(57) ABSTRACT

The present invention provides a device for efficiently heating gas. Specifically, the invention provides a gas heating device for heating a gas by bringing the gas into contact with a heating element, wherein: (1) a plurality of heating elements are provided in a container having at least one gas inlet and at least one gas outlet; (2) an induction coil for electromagnetic induction heating is provided on the periphery of the container; and (3) (a) the heating elements are columnar in shape, and (b) each columnar heating element is provided such that the longitudinal direction of the columnar heating element is parallel to the longitudinal direction of the container.

### TECHNICAL FIELD

The present invention relates to a novel gas heating device.

### BACKGROUND ART

For gas heating devices such as steam generators (steamers), various heating elements have been proposed, including electromagnetic induction heaters as well as resistance heaters.

Japanese Unexamined Patent Publication No. 2003-336801, for example, discloses a high-temperature steam generator comprising a cylindrical insulating ceramic body on which an induction coil is provided, the coil being capable of switching from low frequency to high frequency to conduct electric current; a plurality of disk-like dielectric heating elements having through holes for passage, the heating elements being stacked in layers in the cylindrical insulating ceramic body; and ring-shaped insulating spacers placed between the disk-like dielectric heating elements; wherein a fluid inlet port for supplying fluid into the cylindrical insulating ceramic body is provided at the bottom plate of the insulating body; and a steam outlet port is provided at the top plate of the cylindrical insulating ceramic body for discharging high-temperature steam resulting from heat exchange inside the insulating body by induction heating.

Japanese Unexamined Patent Publication No. 2003-297537, for example, discloses a superheated steam generator comprising either a conductive tubular body that stands vertically, forming a water bearing zone in the lower part of the internal hollow space, or a non-conductive tubular body with conductive materials provided along almost the entire length of the internal hollow space; a water supply portion for supplying water to the water bearing zone; a water level adjustment system for adjusting the water level of the water bearing zone; and an induction coil provided on the periphery of the tubular body from the water bearing zone to the upper part of the internal hollow space.

However, in the steam generator of Japanese. Unexamined Patent Publication No. 2003-336801, a single large disk is used as the heating element at each layer. Since electromagnetic induction heating generates heat at the periphery of a disk, the use of a large disk decreases the efficiency of heat generation.

In the steam generator of Japanese Unexamined Patent Publication No. 2003-297537, although the use of multiple pipes increases the efficiency of heat generation, heat is released outside without sufficient heat transfer from the heating element to steam.

### DISCLOSURE OF THE INVENTION

A principal object of the present invention is to provide a device for efficiently heating gas.

In view of the problems of the prior art, the present inventor conducted extensive research and found that the above object can be achieved by adopting specific constituent features. Based on these findings, the inventor has accomplished the present invention.

The present invention provides a device for heating gas and a method for producing a hydrogen-containing gas as follows:

1. A gas heating device for heating a gas by bringing the gas into contact with a heating element, wherein:

(1) a plurality of heating elements are provided in a container having at least one gas inlet and at least one gas outlet;

(2) an induction coil for electromagnetic induction heating is provided on the periphery of the container; and

(3) (a) the heating elements are columnar in shape, and (b) each columnar heating element is provided such that the longitudinal direction of the columnar heating element is parallel to the longitudinal direction of the container.

2. A gas heating device according to item 1, wherein the value of (the length in the longitudinal direction/the diameter of the base) in all or some of the columnar heating elements is at least 1.

3. A gas heating device according to item 2, wherein the columnar heating elements have the same length in the longitudinal direction, and are provided such that the bases thereof are on the same plane.

4. A gas heating device according to item 2, wherein the columnar heating elements are spaced with substantially equal distances between the sides thereof.

5. A gas heating device according to item 2, wherein the columnar heating elements are polygonal.

6. A gas heating device according to item 2, wherein the columnar heating elements are cylindrical.

7. A gas heating device according to item 2, wherein the columnar heating elements are provided with a heat insulator between them.

8. A gas heating device according to item 1, wherein the value of (the length in the longitudinal direction/the diameter of the base) in all or some of the columnar heating elements is less than 1.

9. A gas heating device according to item 8, wherein the columnar heating elements are stacked such that gas can be passed through gaps therebetween.

10. A gas heating device according to item 8, wherein the columnar heating elements are provided such that the central axes of alternate columnar heating elements with one end adjacent to one end of another columnar heating element are offset.

11. A gas heating device according to any one of items 1 to 10, wherein the columnar heating elements comprise a porous material, the porous material comprising an intermetallic compound, the intermetallic compound comprising aluminum in combination with at least one member selected from the group consisting of iron, cobalt, nickel, ruthenium, rhodium, palladium, osmium, iridium, and platinum; the intermetallic compound has a three-dimensional network skeletal structure; and the porous material has a relative density of not more than about 80%.

12. A gas heating device according to item 11, wherein an oxide layer is formed on all or part of the surface of the porous material.

13. A gas heating device according to item 12, wherein the oxide layer comprises a constituent element of the intermetallic compound.

14. A gas heating device according to any one of items 11 to 13, wherein the porous material has a relative density of 30% to 70%.

15. A gas heating device according to any one of items 11 to 14, wherein the porous material comprises 80% or more by weight of intermetallic compound.

16. A gas heating device according to any one of items 1 to 15, wherein the gas is steam, and the steam is brought into contact with the heating elements to generate a high-temperature superheated steam of 600° C. or higher.

17. A gas heating device according to any one of items 1 to 15, wherein the gas is steam, and the steam is brought into contact with the heating elements to generate a hydrogen-containing gas.

18. A method for producing a hydrogen-containing gas, comprising supplying steam into the gas heating device of any one of items 1 to 17 through the gas inlet and bringing the steam into contact with hot heating elements therein.

19. A gas heating device according to item 11, wherein the porous material is produced by molding a mixed powder that comprises at least two inorganic powders and performing a combustion synthesis reaction on the resulting molded mixed powder.

20. A gas heating device according to item 19, wherein the mixed powder comprises an aluminum powder in combination with an inorganic powder comprising at least one member selected from the group consisting of iron, cobalt, nickel, ruthenium, rhodium, palladium, osmium, iridium, and platinum.

21. A gas heating device according to item 20, wherein the mixed powder further comprises a powder comprising at least one member selected from the group consisting of metals, intermetallic compounds, and ceramics (other than the above inorganic powder and aluminum powder).

22. A gas heating device according to item 19, wherein before the combustion synthesis reaction, the surface of the molded mixed powder is provided with at least one member selected from the group consisting of metals, intermetallic compounds, and ceramics.

The gas heating device of the present invention is described below in detail.

The gas heating device of the invention is a device for heating a gas by bringing the gas into contact with a heating element, wherein:

(1) a plurality of heating elements are provided in a container having at least one gas inlet and at least one gas outlet;

(2) an induction coil for electromagnetic induction heating is provided on the periphery of the container; and

(3) (a) the heating elements are columnar in shape, and (b) each columnar heating element is provided such that the longitudinal direction of the columnar heating element is parallel to the longitudinal direction of the container.

The container has gas inlet(s) and gas outlet(s). Each container may have one gas inlet and one gas outlet or may have a plurality of gas inlets and a plurality of gas outlets. The size of a container is not limited as long as the container can accommodate the heating elements. The material of the container can be suitably selected from known materials according to the kind of gas, etc., as long as the material itself is not affected by electromagnetic induction heating. For example, when the gas is steam, a heat-resistant material such as quartz glass, alumina, mullite, magnesia, silicon nitride, etc., may be used.

An induction coil for electromagnetic induction heating is provided on the periphery of the container. The induction coil may be installed as in known electromagnetic induction heating devices. For example, a conducting wire may be wound in a spiral form on the container from its gas inlet to its gas outlet.

The heating elements in the heating device of the present invention are of columnar shape. Each columnar heating element is provided such that the longitudinal direction of the columnar heating element is substantially parallel to the longitudinal direction of the container. That is, the central axis of each heating element is parallel to the longitudinal direction of the container.

The plurality of heating elements may be the same or different in shape, size, etc. In Embodiment 1 below, it is desirable to use heating elements of at least the same shape and size.

In the heating elements of the present invention, the value of (the length in the longitudinal direction/the diameter of the base) is not limited. In the present invention, there are two cases with respect to this value: the case where this value in all or some of the columnar heating elements is at least 1 (Embodiment 1); and the case where this value in all or some of the columnar heating elements is less than 1 (Embodiment 2). The “diameter of the base” herein means the maximum diameter of the base.

### Embodiment 1

When the above value is at least 1 (especially when the values of all of the columnar heating elements are at least 1), it is desirable that the columnar heating elements have the same length in the longitudinal direction, and be provided such that the bases thereof are on the same plane. In this case, it is also desirable that the columnar heating elements be spaced with substantially equal distances between the sides thereof. Gaps are formed between the sides of the columnar heating elements, and gas is passed through these gaps. While passing through the gaps, the gas is heated. The above distances can be suitably adjusted, and are generally in the range of about 0.1 to about 5 mm.

The cross section of each columnar heating element that is parallel to the base thereof is preferably polygonal. That is, the columnar heating elements used in the present invention are preferably prismatic. Polygons may be any of a triangle, a quadrangle, a pentagon, a hexagon, etc. The above-mentioned gaps can be formed efficiently by adopting such polygonal shapes. In particular, the use of heating elements of the same shape and size helps to form gaps efficiently, as in example 1.

In the present invention, the plurality of columnar heating elements may be provided with spaces between them or with a heat insulator between them. A heat insulator present between the heating elements is capable of effectively preventing or controlling the release (dissipation) of heat generated in the heating elements. The heat insulator may be, for example, a molded heat insulator having a plurality of spaces into which columnar heating elements can be inserted. The heating elements can be provided with a heat insulator between them by placing such a molded heat insulator in a container and inserting the heating elements into the spaces of the molded heat insulator. In this case, gas is heated while passing through the gaps between the insulators and the heating elements.

### Embodiment 2

When the above value is less than 1, the columnar heating elements are in a disk shape. When the columnar heating elements have such a shape, it is desirable that they be stacked such that gas can be passed through gaps therebetween. The configuration in this case is not limited as long as gas is brought into contact with the heating elements while passing through gaps therebetween. For example, the columnar heating elements may be staggered such that the central axes of the columnar heating elements whose ends are adjacent to each other are alternately offset. In this case, it is desirable to use heating elements of the same shape and size.

(Heating of Gas)

When using the device of the present invention to heat a gas, the gas may be brought into contact with heating elements by known electromagnetic induction heating (high-frequency induction heating) methods. For example, when a spiral conducting wire is provided on the periphery of the heating elements and is operated at 1 to 100 kW and 10 to 500 kHz, the heating elements generate heat effectively. In this case, the gas to be heated is introduced through a gas inlet and heated by contact with the heating elements. The heated gas is then discharged through a gas outlet.

(Heating Elements)

Known materials for electromagnetic induction heating may be used for the heating elements of the present invention. It is desirable in the present invention to use a porous material comprising an intermetallic compound, the intermetallic compound comprising aluminum in combination with at least one member selected from the group consisting of iron, cobalt, nickel, ruthenium, rhodium, palladium, osmium, iridium, and platinum; wherein the intermetallic compound has a three-dimensional network skeletal structure, and the porous material has a relative density of not more than about 80%.

The intermetallic compound is not limited as long as it is formed by the combination of components mentioned above; it encompasses known intermetallic compounds. Examples of intermetallic compounds include Ni—Al, Ir—Al, Co—Al, Pt—Al, etc. Of these, Ni—Al, Ir—Al, etc., are especially preferable.

The relative density of the porous material may be suitably set, usually within the limit of not more than 80%, depending on its use, purpose, etc. The relative density thereof is preferably 30% to 70%, more preferably 30% to 60%, and most preferably 30% to 55%.

The porous material preferably has an oxide layer formed on all or part of the surface of the skeletal structure. The capability of producing a porous material with such a unique structure can be increased especially by the later-described production method. This unique structure contributes to excellent properties in terms of heat resistance, chemical resistance, etc.

The oxide layer contains a constituent element of the intermetallic compound. For example, when the intermetallic compound having the above-mentioned skeletal structure is Ni—Al, the resulting oxide layer generally consists of aluminum oxide. The thickness of the oxide, which is not limited, is generally about 1 to about 100 μm.

Although the content of intermetallic compound in the porous material varies according to its use, the kind of intermetallic compound, etc., it is usually 80% or more by weight, and preferably 90% to 100% by weight.

(Method for Producing Heating Elements)

The heating elements may be produced by, for example, molding a mixed powder that comprises at least two inorganic powders and performing a combustion synthesis reaction on the resulting molded mixed powder.

The mixed powder comprises at least two inorganic powders, the combination of which is not limited as long as it promotes combustion synthesis reaction. The kinds of inorganic powder are not restricted, and suitable inorganic powders may be selected according to use, desired properties, etc. Examples of inorganic powders include powders of metals, metal oxides, metal carbides, metal nitrides, metal salts (nitrates, chlorides, sulfates, carbonates, acetates, oxalates, etc.), metal hydroxides, etc.

Such inorganic powders and mixed powders are not limited with respect to their average particle diameter as long as they can be molded. The diameter thereof is usually in the range of about 0.1 to about 200 μm.

In particular, the mixed powder in the present invention preferably comprises an inorganic powder (inorganic powder A) of at least one member selected from the group consisting of Fe, Co, Ni, Ru, Rh, Pd, Os, Ir, and Pt, in combination with an inorganic powder (inorganic powder B) of Al.

The ratio between inorganic powder A and inorganic powder B may be suitably determined according to the kind of powders, use of final products, etc. The inorganic powder A/inorganic powder B ratio (molar ratio) is usually about 1/0.2-5, and preferably 1/0.3-3.

In the present invention, if necessary, other inorganic powder(s) (inorganic powder C) may be optionally used in combination with inorganic powders A and B. For example, the mixed powder preferably further contains an inorganic powder of at least one member selected from the group consisting of metals (elemental metals such as Ag, Cu, Sn, etc.), intermetallic compounds, oxide ceramics, boride ceramics, nitride ceramics, carbide ceramics, and silicide ceramics. Specific examples of optional inorganic powders include titanium oxide, zirconium oxide, hafnium oxide, boron oxide, silicon oxide, aluminum oxide, calcium oxide, magnesium oxide, titanium boride, zirconium boride, hafnium boride, titanium carbide, zirconium carbide, hafnium carbide, titanium silicide, zirconium silicide, hafnium silicide, etc. Such inorganic powders may be used singly or in combination of two or more.

The proportion of inorganic powder C may be suitably determined according to the kind of inorganic powder C, other inorganic powders, etc. The proportion of inorganic powder C is usually in the range of about 1% to about 50%, and preferably 10% to 20%, of the weight of the mixed powder.

In the present invention, a mixed powder containing such inorganic powders is molded to form a molded mixed powder. Molding may be conducted by known methods for molding ceramics. Examples thereof include press molding, slip casting, injection molding, isostatic molding, etc. Molding conditions such as molding pressure may be suitably determined according to the kind of inorganic powders, use of final products, etc. The molded mixed powder is not limited in shape and may be, for example, columnar, tubular (pipe-shaped), spherical, rectangular parallelepiped-shaped, tabular, etc.

In the present invention, before the combustion synthesis reaction, the surface of the molded mixed powder may be provided with at least one member selected from the group consisting of metals, intermetallic compounds, and ceramics. This allows the metals and/or intermetallic compounds and/or ceramics to melt and adhere to the surface of the molded mixed powder at the time of the combustion synthesis, resulting in a modified surface. Examples of metals intermetallic compounds, and ceramics include titanium, zirconium, hafnium, calcium, magnesium, aluminum, chromium, vanadium, copper, silver, gold, platinum, iron, nickel, cobalt, nickel titanium, titanium aluminum, nickel aluminum, titania, silica, calcia, magnesia, alumina, chromia, hematite, titanium boride, zirconium boride, hafnium boride, titanium carbide, zirconium carbide, hafnium carbide, titanium silicide, zirconium silicide, hafnium silicide, etc. These may be provided by, for example, a method of applying a dispersion liquid or paste containing a powder of at least one of such metals, intermetallic compounds, and ceramics dispersed in a suitable solvent, or by a dipping method, spraying method, spin coating method, etc.

Subsequently, the molded mixed powder is subjected to a combustion synthesis reaction. The combustion synthesis reaction may be performed using ordinary combustion synthesis methods, operating conditions, etc. For example, the reaction can be initiated by locally heating the molded mixed powder by means of an electric discharge, laser irradiation, ignition using a carbon heater, etc. Once the reaction starts, it proceeds with spontaneous generation of heat, finally producing the intended porous material. The reaction time varies according to the size of the molded mixed powder, and iasusually about several seconds to about several minutes.

The kinds of atmospheres in which the combustion synthesis reaction may be performed are broadly classified into two types: (1) atmospheric air (air) and other oxidizing atmospheres (method 1), and (2) inert gas atmospheres and vacuum (method 2).

In method 1, the atmosphere is usually atmospheric air (air) or another oxidizing atmosphere. The combustion synthesis reaction can be suitably performed, for example, in air at a pressure of 0.1 or more atmospheres (preferably 1 or more atmospheres).

In method 2, the atmosphere is usually a vacuum or an inert gas atmosphere. The combustion synthesis reaction can be carried out, for example, in an inert gas atmosphere using an inert gas such as argon, nitrogen, helium, etc.

Methods 1 and 2 each provide the intermetallic compound porous material of the present invention, which has a three-dimensional network structure. In particular, the pores (continuous holes) of the porous material are preferably through holes. Although the relative density of the porous material is not limited, it is preferably about 30% to about 70%. The relative density or the porosity of the porous material can be controlled by molded mixed powder density, combustion synthesis reaction temperature, atmosphere pressure, etc. Although the diameter of the above pores is not limited, it is usually several tens of microns. Pores of relatively uniform size are especially desirable.

Furthermore, method 1 provides a porous material with features 1 and 2 below. Specifically, a multilayer intermetallic compound porous material can be obtained having a surface oxide and an interior intermetallic compound.

(1) The intermetallic compound porous material has an oxide layer formed on all or part of the surface thereof. The thickness (depth) of the oxide layer is not limited, and may be suitably determined according to the use, purpose, size, etc., of the porous material. The thickness can be controlled by pressure adjustment, etc., of the above-mentioned atmosphere.

(2) The intermetallic compound is present in portions other than the oxide layer. In particular, it is preferable that the interior of the porous material be mainly composed of the intermetallic compound.

In contrast, method 2 provides an intermetallic compound porous material having no surface oxide. That is, the porous material obtained by method 1 is multilayered with layers of oxide and intermetallic compound, while the porous material of method 2 is substantially composed of a single layer of intermetallic compound. The porous material of method 2, however, may contain other components within limits such that the effects of the present invention are not impaired.

The present invention encompasses the intermetallic compound porous materials obtained by methods 1 and 2. As mentioned above, the composition and structure of the porous material of the invention can be suitably adjusted according to the kind of inorganic powder, etc. For example, when a mixed powder of nickel powder and aluminum powder, which are inorganic powders, is molded, and the molded mixed powder undergoes a combustion synthesis reaction in air or in another oxidizing atmosphere, then an intermetallic compound porous material can be obtained having an aluminum oxide (alumina) layer formed on the surface, with the interior of the material being composed of nickel aluminum.

The present invention also encompasses, for example, intermetallic compound porous materials having gradient structures, wherein the surface of a porous material is formed by an oxide layer, and the deeper into the interior one goes, the higher the proportion of intermetallic compound.

The porous material of the present invention can be used for the various uses to which conventidnal porous materials have been put. For example, it is suitable for use in heating elements (heating elements to decompose dioxin-containing harmful gases, heating elements to generate superheated steam, etc.), filters (diesel particulate filters, etc.), catalysts and catalyst supports, sensors, biomaterials (artificial bones, dental implants, artificial joints, etc.), antibacterial/antifouling materials, vaporizers, radiator plates and heat exchangers, electrode materials, semiconductor wafer suction plates, adsorbents, vent holes for outgassing, vibration-proof/soundproof materials, deoxidizers, etc.

Having excellent workability, the porous material can be worked into desirable shapes for the various uses mentioned above. Working can be conducted using known methods such as cutting and/or using known equipment.

Since this porous material has particularly excellent heat resistance and corrosion resistance, little deterioration thereof occurs in high-temperature superheated steam. It therefore can be used as a heater for steam heating. When using the porous material of the invention as a heater for steam heating, it is possible to produce hydrogen-containing gas efficiently. The porous material of the invention can thus be suitably used as a heater for producing a hydrogen-containing gas. Ordinary metal heaters and carbon heaters, when used in superheated steam, deteriorate at 600° C. or higher, and the resulting change of electrical resistance not only lessens their stability as heaters but also can make heating impossible. The heater according to the present invention is advantageous in that it hardly deteriorates in superheated steam of 800° C. or higher, and therefore can be used stably for a long time.

When the porous material is used as a heater for hydrogen-containing gas production, the heater may be, for example, heated preferably to 600° C. or higher and be brought into contact with steam to generate a gas that contains hydrogen produced by the decomposition of the steam. The underlying principle is unknown; however, it is considered that as well as being a heating element, the porous material, when brought into contact with steam, promotes decomposition into hydrogen and oxygen. It is further considered that the resulting oxygen undergoes chemical absorption by the intermetallic compound. The principal component of the obtained gas is hydrogen.

The gas heating device of the present invention achieves excellent heating efficiency since a plurality of heating elements are provided by a specific configuration method. In particular, when the heating elements are provided with a heat insulator between them, heating efficiency is further enhanced.

When using specific intermetallic compound porous materials as heating elements, the device of the present invention achieves outstanding durability based on its excellent properties in terms of corrosion resistance, chemical resistance, heat resistance, abrasion resistance, etc., and also achieves excellent economic efficiency.

### BEST MODE FOR CARRYING OUT THE INVENTION

The present invention is described in further detail with reference to the following examples. However, the invention is not limited to these examples.

### PRODUCTION EXAMPLE 1

A porous material comprising an intermetallic compound was produced as a heating element. A mixture of iridium powder and aluminum powder in a molar ratio of 1:1 was subjected to press molding to form a hexagonal columnar molded mixed powder with a length of 100 mm, the diameter of the inscribed circle of its hexagonal base being 20 mm. One end of the molded mixed powder placed on a graphite board was ignited in air by electric discharge, and a high-temperature combustion wave (about 2100° C.) propagated, completing the combustion synthesis reaction in about 10 seconds. As a result, a porous body with a relative density of 50% was obtained in almost the same shape as the molded mixed powder. It was confirmed by electron microscope that this porous body had a three-dimensional network structure as shown in FIG. 1. X-ray powder diffraction analysis showed that the surface layer of the porous body was mainly composed of aluminum oxide and also contained an iridium aluminum intermetallic compound, and that the interior of the porous body was mainly composed of an iridium aluminum intermetallic compound. It was further confirmed that the bottom layer of the porous body was composed of the same iridium aluminum intermetallic compound as in the interior, since the bottom layer, which was in contact with the graphite board, was isolated from the air. The porous body was used for the heating elements in Example 1 below.

### PRODUCTION EXAMPLE 2

A porous material comprising an intermetallic compound was produced as a heating element. A mixture of nickel powder and aluminum powder in a molar ratio of 1:1 was charged into a metal mold and was subjected to press molding to form a disk-shaped pellet with a diameter of 20 mm and a thickness of 5 to 20 mm. One end of the pellet was ignited in argon by a YAG laser, and a combustion wave (about 1600° C.) propagated, completing the combustion synthesis reaction in about 3 seconds. As a result, a porous body with a relative density of 45% was obtained in almost the same shape as the molded mixed powder. X-ray powder diffraction analysis showed that the porous body was mainly composed of a nickel aluminum intermetallic compound, which was indicated as NiAl. The porous body was used for the heating elements in Example 2 below.

### PRODUCTION EXAMPLE 3

A porous material comprising an intermetallic compound was produced as a heating element. A mixture of cobalt powder and aluminum powder in a molar ratio of 1:0.9 was charged into a metal mold and was subjected to press molding to form a cylindrical molded mixed powder with a height of 100 mm and a diameter of 20 mm. One end of the molded mixed powder was ignited in argon by a YAG laser, and a combustion wave (about 1600° C.) propagated, completing the combustion synthesis reaction in about 5 seconds. As a result, a porous body with a relative density of 45% was obtained in almost the same shape as the molded mixed powder. X-ray powder diffraction analysis showed that the porous body was mainly composed of a cobalt aluminum intermetallic compound, which was indicated as CoAl. The porous body was used for the heating elements in Example 3 below.

### EXAMPLE 1

The device of FIG. 2(a) was produced for Embodiment 1. Container 1, which accommodates heating elements, is made of quartz glass. This container comprises a cylindrical part 2, a bottom cover 3, a gas inlet 3a provided in the bottom cover, a top cover 4, a gas outlet 4a provided in the top cover, and a heat insulator 5 provided on the periphery of the cylindrical part. Induction coil 6 is provided on the periphery of the container (heat insulator 5), being wired such that an electric current can be passed through it. Nineteen hexagonal columnar heating elements 7 are placed in the container. These heating elements are provided such that the bases thereof are on the same plane. Porous board 9 is in contact with this plane. In this case, as shown in FIG. 2(b), the heating elements are spaced with substantially equal distances therebetween (about 0.5-1 mm) so as to provide gaps 8. When an electric current is passed through the induction coil, the heating elements generate heat via electromagnetic induction heating. Steam is then introduced through gas inlet 3a. The introduced steam, when passing through the above-mentioned gaps, contacts the heating elements, thus being heated. The heated steam, which partly decomposes into hydrogen gas, etc., is then discharged through gas outlet 4a as a hydrogen-containing gas. High-frequency induction heating was carried out at 5 kW and about 400 kHz. As a result, a superheated steam gas (1000° C.) containing at least 10 vol % of hydrogen was generated, and discharged through gas outlet 4a.

### EXAMPLE 2

The device of FIG. 3(a) was produced for Embodiment 2. Container 1, which accommodates heating elements, is made of alumina. This container comprises a cylindrical part 2, a bottom cover 3, a gas inlet 3a provided in the bottom cover, a top cover 4, a gas outlet 4a provided in the top cover, and a heat insulator 5 provided on the periphery of the cylindrical part. Induction coil 6 is provided on the periphery of the container (heat insulator 5), being wired such that an electric current can be passed through it. In the container, sets 9, each of which is formed of a plurality of (disk-shaped) cylindrical heating elements 8, are stacked to ten levels.

FIG. 3(b) shows a perspective view at cross section A of FIG. 3(a). As shown in FIG. 3(b), the heating elements are staggered such that the central axes of the heating elements at mutually adjacent levels are alternately offset, thus securing gaps for the passage of gas. FIGS. 3(c) and(d) show cross sections A and B, respectively, of FIG. 3(a). As shown in FIGS. 3(c) and (d), there are 14 heating elements at each level, and these heating elements are staggered at mutually adjacent levels such that the central axes thereof are alternately offset. When an electric current is passed through the induction coil, the heating elements generate heat via electromagnetic induction heating. Steam is then introduced through gas inlet 3a. The introduced steam, when passing through the above-mentioned gaps, contacts the heating elements, thus being heated. The heated steam, which partly decomposes into hydrogen gas, etc., is then discharged through gas outlet 4a as a hydrogen-containing gas.

### EXAMPLE 3

The device of FIG. 4 was produced for Embodiment 1. Container 1, which accommodates heating elements, is made of silicon nitride. This container comprises a cylindrical part 2, a bottom cover 3, a gas inlet 3a provided in the bottom cover, a top cover 4, and a gas outlet 4a provided in the top cover. FIG. 5 shows the structure of the top cover. FIG. 6 shows the structure of the cylindrical part. FIG. 7 shows the structure of the bottom cover.

Cylindrical part 2 is made of fireproof material (molded heat insulator: firebrick) that is not affected by electromagnetic induction heating. The cylindrical part has seven tubular spaces into which columnar heating elements can be disposed as shown in FIG. 6. Seven cylindrical heating elements 8 are provided that roughly fit into these spaces. A gap of about 1-2 mm is formed between the cylindrical part and each heating element so as to allow the passage of gas through the gap.

An induction coil (not shown) is provided on the periphery of the container, being wired such that an electric current can be passed through it. When an electric current is passed through the induction coil, the heating elements generate heat via electromagnetic induction heating. Steam is then introduced through gas inlet 3a of the bottom cover made of fireproof material (molded heat insulator) that is not affected by electromagnetic induction heating. The introduced steam, when passing through the above-mentioned gaps, contacts the heating elements, thus being heated. The heated steam, which partly decomposes into hydrogen gas, etc., is then discharged as a hydrogen-containing gas through gas outlet 4a of the top cover made of fireproof material (molded heat insulator) that is not affected by electromagnetic induction heating.

### BRIEF DESCRIPTION OF THE DRAWINGS

FIG. 1 shows the internal structure of the porous body obtained in Production Example 1.

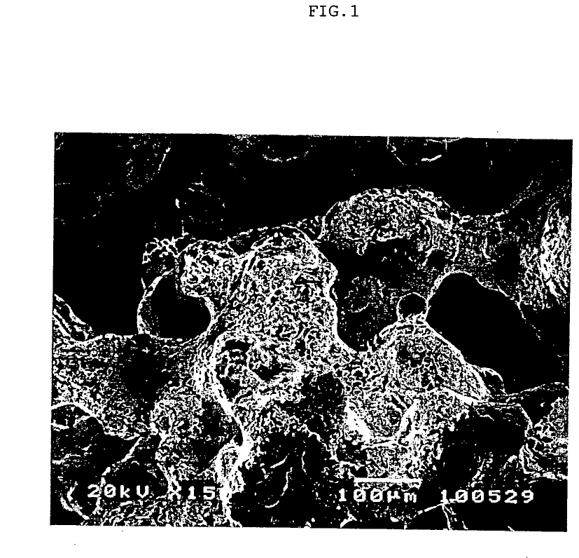

FIG. 2 is a schematic diagram of the gas heating device in Example 1.

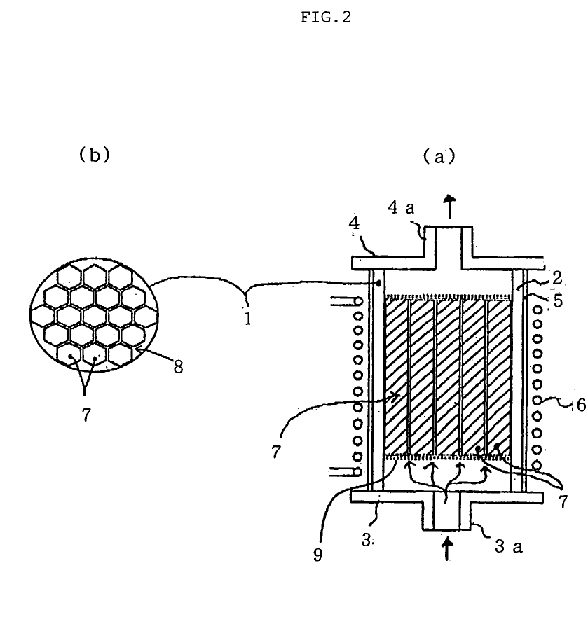

FIG. 3 is a schematic diagram of the gas heating device in Example 2.

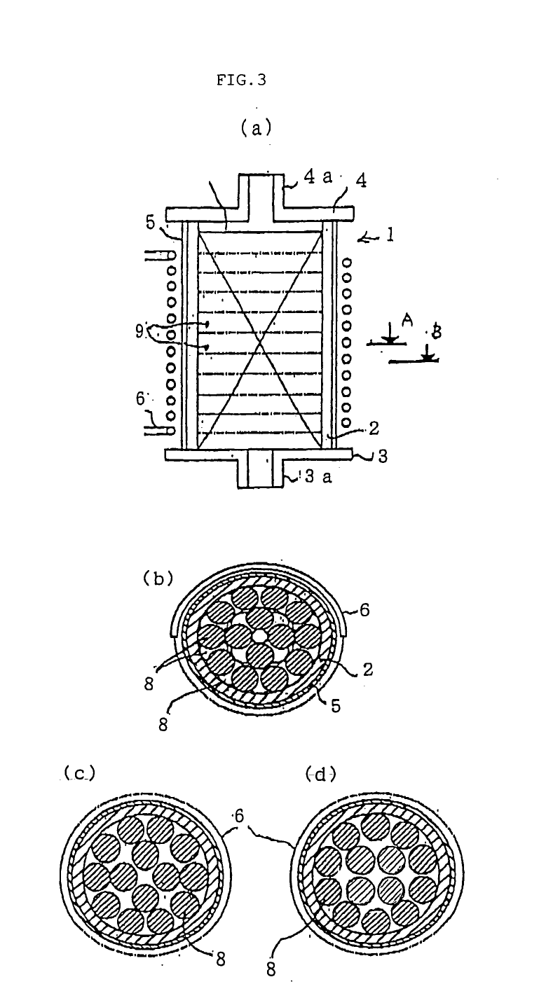

FIG. 4 is a schematic diagram of the gas heating device in Example 3.

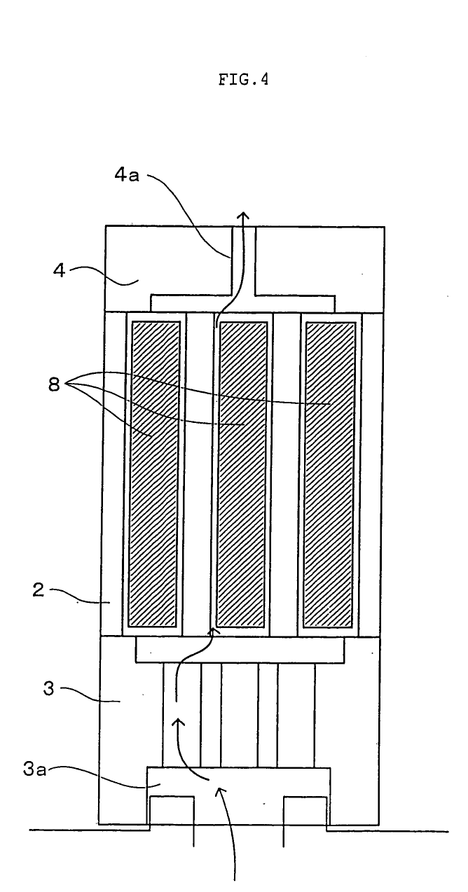

FIG. 5 is a schematic diagram of the top cover of the gas heating device in Example 3.

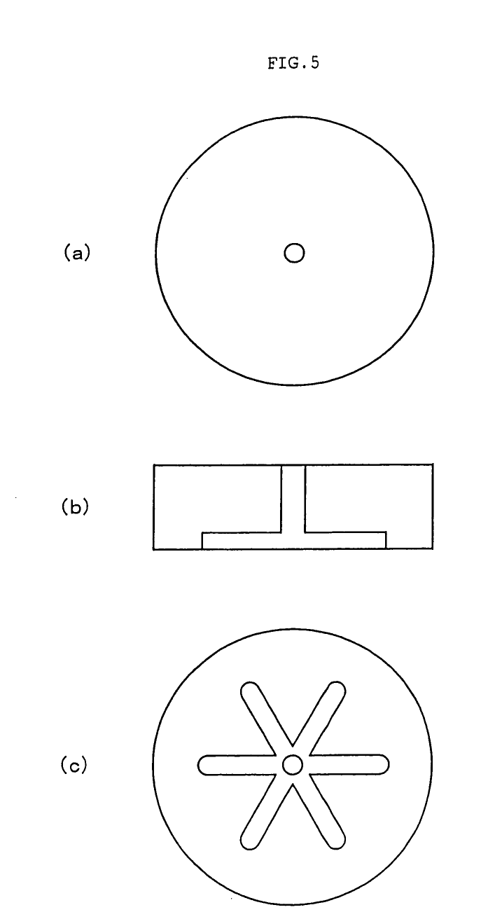

FIG. 6 is a schematic diagram of the cylindrical part of the gas heating device in Example 3.

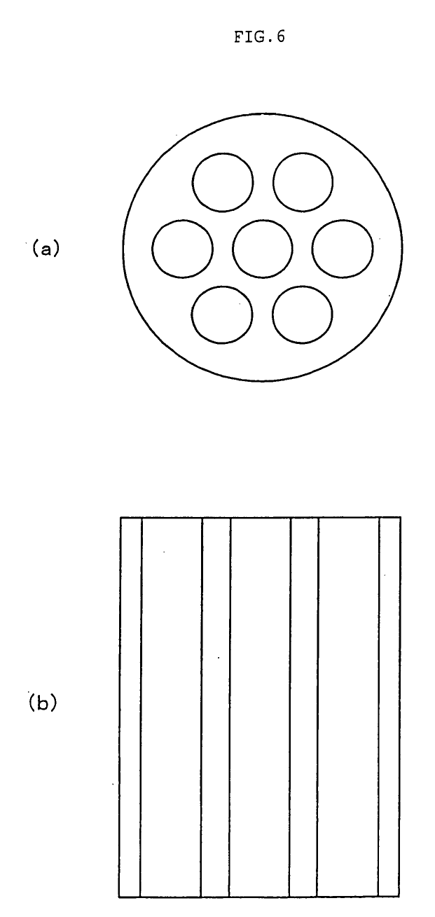

FIG. 7 is a schematic diagram of the bottom cover of the gas heating device in Example 3.

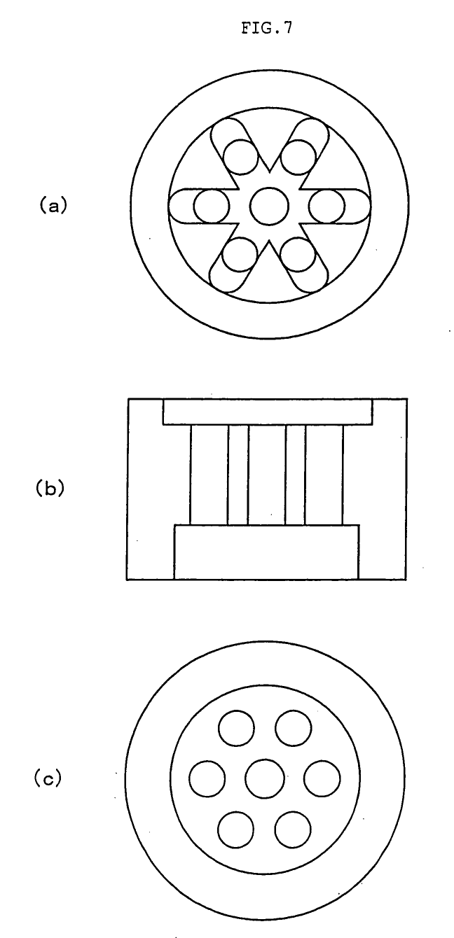

1. A gas heating device for heating a gas by bringing the gas into contact with a heating element, wherein:
(1) a plurality of heating elements are provided in a container having at least one gas inlet and at least one gas outlet;
(2) an induction coil for electromagnetic induction heating is provided on the periphery of the container; and
(3) (a) the heating elements are columnar in shape, and (b) each columnar heating element is provided such that the longitudinal direction of the columnar heating element is parallel to the longitudinal direction of the container.

2. A gas heating device according to claim 1, wherein the value of (the length in the longitudinal direction/the diameter of the base) in all or some of the columnar heating elements is at least 1.

3. A gas heating device according to claim 2, wherein the columnar heating elements have the same length in the longitudinal direction, and are provided such that the bases thereof are on the same plane.

4. A gas heating device according to claim 2, wherein the columnar heating elements are spaced with substantially equal distances between the sides thereof.

5. A gas heating device according to claim 2, wherein the columnar heating elements are polygonal.

6. A gas heating device according to claim 2, wherein the columnar heating elements are cylindrical.

7. A gas heating device according to claim 2, wherein the columnar heating elements are provided with a heat insulator between them.

8. A gas heating device according to claim 1, wherein the value of (the length in the longitudinal direction/the diameter of the base) in all or some of the columnar heating elements is less than 1.

9. A gas heating device according to claim 8, wherein the columnar heating elements are stacked such that gas can be passed through gaps therebetween.

10. A gas heating device according to claim 8, wherein the columnar heating elements are provided such that the central axes of alternate columnar heating elements with one end adjacent to one end of another columnar heating element are offset.

11. A gas heating device according to claim 1, wherein the columnar heating elements comprise a porous material, the porous material comprising an intermetallic compound, the intermetallic compound comprising aluminum in combination with at least one member selected from the group consisting of iron, cobalt, nickel, ruthenium, rhodium, palladium, osmium, iridium, and platinum; the intermetallic compound has a three-dimensional network skeletal structure; and the porous material has a relative density of not more than about 80%.

12. A gas heating device according to claim 11, wherein an oxide layer is formed on all or part of the surface of the porous material.

13. A gas heating device according to claim 12, wherein the oxide layer comprises a constituent element of the intermetallic compound.

14. A gas heating device according to claim 11, wherein the porous material has a relative density of 30% to 70%.

15. A gas heating device according to claim 11, wherein the porous material comprises 80% or more by weight of intermetallic compound.

16. A gas heating device according to claim 1, wherein the gas is steam, and the steam is brought into contact with the heating elements to generate a high-temperature superheated steam of 600° C. or higher.

17. A gas heating device according to claim 1, wherein the gas is steam, and the steam is brought into contact with the heating elements to generate a hydrogen-containing gas.

18. A method for producing a hydrogen-containing gas, comprising supplying steam into the gas heating device of claim 1 through the gas inlet and bringing the steam into contact with hot heating elements therein.

19. A method for producing a high-temperature superheated steam of 600° C. or higher, comprising supplying steam into the gas heating device of claim 1 through the gas inlet and bringing the steam into contact with hot heating elements therein.
